(19) United States
(12) Patent Application Publication
(10) Pub. No.: US 2021/0019541 A1
(43) Pub. Date: Jan. 21, 2021

(54) TECHNOLOGIES FOR TRANSFERRING VISUAL ATTRIBUTES TO IMAGES

(71) Applicant: QUALCOMM Incorporated, San Diego, CA (US)

(72) Inventors: Zhen WANG, San Diego, CA (US); Lei WANG, Clovis, CA (US); Ning BI, San Diego, CA (US); Yingyong QI, San Diego, CA (US)

(21) Appl. No.: 16/516,134

(22) Filed: Jul. 18, 2019

(51) Int. Cl. G06K 9/00; G06K 9/62

(52) U.S. Cl. CPC G06K 9/00926; G06K 9/00281; G06K 9/6215; G06K 9/00288

(57) ABSTRACT

Systems, methods, and computer-readable media are provided media for transferring visual attributes to images. In some examples, a system can obtain a first image associated with a user; generate a second image including image data from the first image modified to add a first visual attribute transferred from one or more images or remove a second visual attribute in the image data; compare a first set of features from the first image with a second set of features from the second image; determine, based on a comparison result, whether the first image and the second image match at least partially; and update a library of user verification images to include the second image when the first image and the second image match at least partially.

### TECHNICAL FIELD

The present disclosure generally relates to facial recognition and, more specifically, to transferring facial visual attributes to images for facial recognition systems.

### BACKGROUND

The ubiquity of computing devices has created an enormous demand for digital data and transactions. Users of computing devices are increasingly reliant on digital data. This digital revolution has created significant security challenges for users and entities, as security exploits become increasingly prevalent and sophisticated. One common security exploit faced by users and entities involves user authentication or verification attacks, where attackers attempt to gain unauthorized access to a device and its associated data without the correct authentication or identification credentials. For example, attackers frequently attempt to gain access to a user's device by impersonating the user or otherwise tricking the user's device into giving the attacker access to the device without proper user authentication or verification. As a result, there is an ongoing need for effective personal verification and identification technologies to guard against unauthorized user access to computing devices and digital data.

Biometrics technologies have rapidly emerged as popular security options for personal verification and authentication. For example, facial recognition tools have been implemented for facial biometric verification and authentication in user devices. To perform facial biometric verification and authentication, facial recognition tools can compare a stored biometric facemap obtained during user enrollment with a user's facial features detected by a camera. The facial biometric verification and authentication tools can provide a higher level of security than the traditional use of passwords and pins, which can be relatively easy to steal or guess. However, facial biometric verification and authentication tools often produce incorrect facial recognition results, which can have a negative impact on the accuracy, stability, and effectiveness of such facial biometric verification and authentication tools.

### BRIEF SUMMARY

Disclosed herein are systems, methods, and computer-readable media for transferring visual attributes to images. The technologies herein can be implemented to transfer visual attributes to images for use in various applications such as, for example and without limitation, computational photography; image-based recognition, verification, or authentication applications; virtual reality photography; animation; artistic effects; among others.

According to at least one example, a method for transferring visual attributes to images is provided. An example method can include obtaining a first image associated with a user; generating a second image including image data from the first image modified to add a first visual attribute transferred from one or more images or to remove a second visual attribute in the image data; comparing a first set of features from the first image with a second set of features from the second image; determining, based on a comparison result, whether the first image and the second image match at least partially; and when the first image and the second image match at least partially, updating a library of user verification images to include the second image.

According to at least some examples, apparatuses for transferring visual attributes to images are provided. In one example, an apparatus can include memory and one or more processors implemented in circuitry and configured to: obtain a first image associated with a user; generate a second image including image data from the first image modified to add a first visual attribute transferred from one or more images or to remove a second visual attribute in the image data; compare a first set of features from the first image with a second set of features from the second image; determine, based on a comparison result, whether the first image and the second image match at least partially; and when the first image and the second image match at least partially, update a library of user verification images to include the second image.

In another example, an apparatus can include means for obtaining a first image associated with a user; generating a second image including image data from the first image modified to add a first visual attribute transferred from one or more images or to remove a second visual attribute in the image data; comparing a first set of features from the first image with a second set of features from the second image; determining, based on a comparison result, whether the first image and the second image match at least partially; and when the first image and the second image match at least partially, updating a library of user verification images to include the second image.

According to at least one example, non-transitory computer-readable media are provided for transferring visual attributes to images. An example non-transitory computer-readable medium can store instructions that, when executed by one or more processors, cause the one or more processor to obtain a first image associated with a user; generate a second image including image data from the first image modified to add a first visual attribute transferred from one or more images or to remove a second visual attribute in the image data; compare a first set of features from the first image with a second set of features from the second image; determine, based on a comparison result, whether the first image and the second image match at least partially; and when the first image and the second image match at least partially, update a library of user verification images to include the second image.

In some aspects, the methods, apparatuses, and computer-readable media described above can capture, in response to a request by the user to authenticate at a device containing the updated library of user verification images, a third image of the user; compare the third image with one or more user verification images in the library of user verification images, the user verification images including the first image and/or the second image; and when the third image matches at least one of the one or more user verification images, authenticate the user at the device.

In some aspects, comparing the third image with the one or more user verification images in the library of user verification images can include comparing identity information associated with the third image with identity information associated with the one or more user verification images; and determining whether the identity information associated with the third image and the identity information associated with the one or more user verification images correspond to a same user. In other aspects, comparing the third image with the one or more user verification images in the library of user verification images can include comparing one or more features extracted from the third image with a set of features extracted from the one or more user verification images; and determining whether the one or more features extracted from the third image and at least some of the set of features extracted from the one or more user verification images match.

In some examples, determining whether the first image and the second image match at least partially can include comparing a first image data vector associated with the first image with a second image data vector associated with the second image, the second image data vector including the image data associated with the second image; and determining whether the first image data vector associated with the first image and the second image data vector associated with the second image match at least partially.

Moreover, in some examples, generating the second image can include transferring the first visual attribute from the first image to the second image, wherein the transferring of the first visual attribute is performed while maintaining facial identity information associated with at least one of the first image and the second image. In other examples, the image data from the first image can include the second visual attribute, and generating the second image can include removing the second visual attribute from the image data, the second visual attribute being removed from the image data while maintaining facial identity information associated with at least one of the first image and the second image.

In some examples, generating the second image is based on a plurality of training facial images having different visual attributes. In other examples, generating the second image and determining whether the first image and the second image match at least partially are performed using one or more Variational Autoencoder-Generative Adversarial Networks (VAE-GANs), wherein each of the one or more VAE-GANs includes an encoder, a generator, a discriminator, and/or an identifier.

In some aspects, the methods, apparatuses, and computer-readable media described above can enroll one or more facial images associated with the user into the library of user verification images; and generate the second image based on at least one facial image from the one or more facial images in the library of user verification images and one or more training facial images having one or more different visual attributes than the at least one facial image from the one or more facial images. In some examples, enrolling the one or more facial images can include extracting a set of features from each facial image in the one or more facial images and storing the set of features in the library of user verification images, wherein generating the second image includes transferring at least one of the one or more different visual attributes from the one or more training facial images to the image data associated with the second image.

In some aspects, the image data can include a set of image data from a facial image generated based on the first image. Moreover, in some aspects, the first visual attribute and the second visual attribute can include eye glasses, clothing apparel, hair, one or more color features, one or more brightness features, one or more image background features, and/or one or more facial features.

In some aspects, the apparatuses described above can include a mobile computing device such as, for example and without limitation, a mobile phone, a head-mounted display, a laptop computer, a tablet computer, a smart wearable device (e.g., smart watch, smart glasses, etc.), and the like.

In some aspects, the apparatuses described above can include an image sensor and/or a display device.

This summary is not intended to identify key or essential features of the claimed subject matter, and is not intended to be used in isolation to determine the scope of the claimed subject matter. The subject matter should be understood by reference to appropriate portions of the entire specification of this disclosure, the drawings, and the claims.

The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles described above will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 is a block diagram illustrating an example image processing system, in accordance with some examples;

FIG. 2 illustrates an example system flow for transferring visual attributes to images, in accordance with some examples;

FIG. 3A illustrates an example system testing flow for transferring visual attributes in one example attribute domain to an image in another attribute domain, in accordance with some examples;

FIG. 3B illustrates an example system flow for removing visual attributes in one example attribute domain from an image in a different attribute domain, in accordance with some examples;

FIG. 4 is a diagram of an example implementation of a discriminator used to distinguish images in accordance with some examples;

FIG. 5 illustrates an example configuration of a neural network that can be implemented by one or more components for transferring visual attributes to or from images, in accordance with some examples;

FIG. 6 illustrates an example configuration of a residual network (ResNet) model that can be implemented by an encoder to map input image data to a vector space or code of a certain dimensionality, in accordance with some examples;

FIG. 7 illustrates an example facial verification use case in accordance with some examples;

FIG. 8 illustrates an example method for transferring visual attributes to images, in accordance with some examples; and

FIG. 9 illustrates an example computing device, in accordance with some examples.

### DETAILED DESCRIPTION

Certain aspects and embodiments of this disclosure are provided below. Some of these aspects and embodiments may be applied independently and some may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments and features only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously noted, while considerable progress has been made in the field of face recognition, face verification and authentication tools still face considerable limitations and challenges from numerous real-world scenarios. For example, reference images stored in image verification databases for verification are typically captured under strictly controlled conditions, which may require proper and uniform illumination, an empty background, a neutral expression without makeup or occlusions, etc. However, in real-world scenarios, unconstrained conditions with illumination changes, visual attribute variations, etc., can cause failures or inaccuracies in face recognition and verification results produced by face verification and authentication tools.

In some cases, to eliminate illumination and background variations, an infrared (IR) camera, which generates grayscale images by recording reflected short-wave infrared light, can be used by face verification systems. However, in contrast to illumination changes, visual attribute variations are generally much more complicated. Visual attribute variations can refer to changes in facial attributes such as, for example, facial attribute variations caused by age, makeup, facial expression, etc., as well as visible objects and occlusions such as eye glasses, scarves, hats, hair, and so forth. In many cases, visual attribute variations can be a significant limitation and challenge encountered by face verification systems in real-world scenarios.

To address these and other challenges, at least some approaches herein can involve transferring attributes from a probe image to a reference image, or vice versa. The transfer of attributes between two image domains can be an “image-to-image translation” problem. In some implementations, generative adversarial networks (GANs) can be used for image-to-image translations. GANs can be quite effective at generating images. The performance of a GAN used for image-to-image translation can often depend on the adversarial loss that allows generated images to be indistinguishable from real ones. However, a GAN generally can only perform uni-directional translation. Thus, in some cases, bi-directional translation can be performed using two trained networks.

In some examples, the approaches herein provide a framework that allows visual attributes to be transferred to, or removed from, specific images used for face verification. This transfer of visual attributes can provide consistency of visual attributes in both probe and reference images. In some cases, such consistency can be implemented by adding one or more visual attributes from the probe image to the corresponding reference image, or removing from the probe image one or more visual attributes that are not included in the reference image. Moreover, to avoid changing facial identity features when transferring visual attributes to an image or removing visual attributes from an image, the approaches herein can implement a face identifier that keeps face identity information unchanged after visual attribute transfers or modifications. The combination of visual attribute consistency and identity maintenance can enhance the robustness of the face verification system.

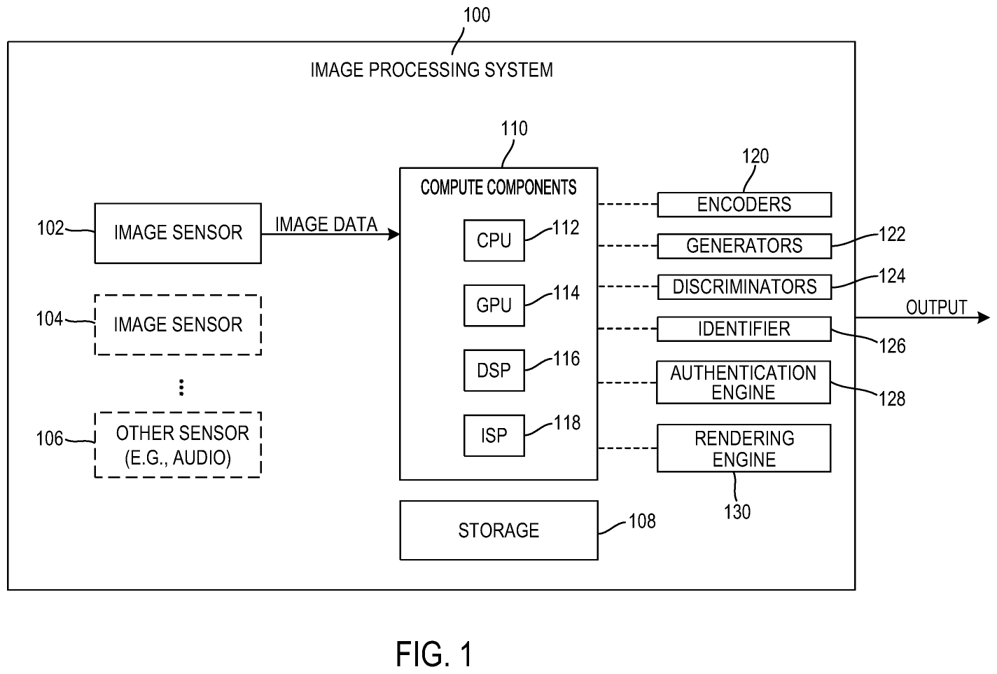

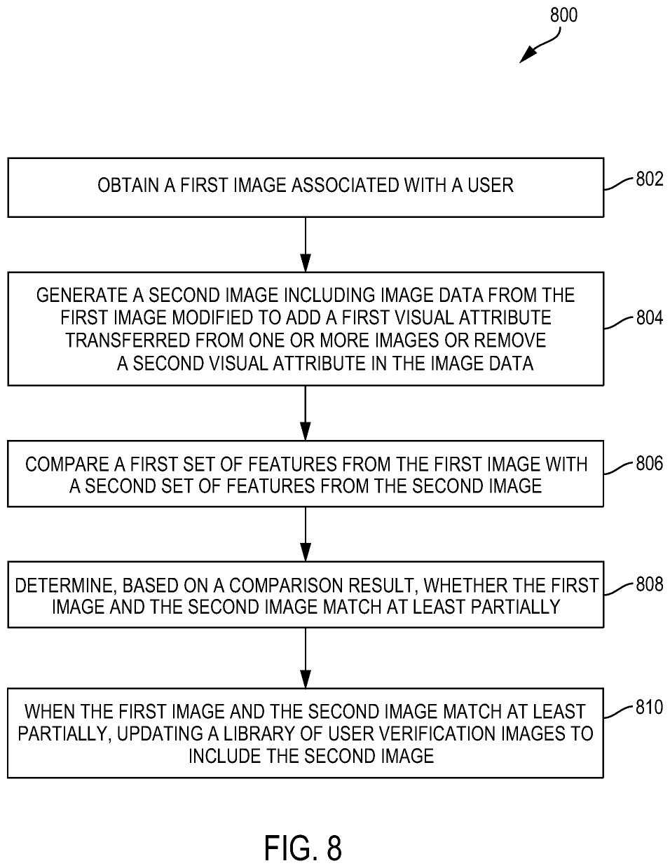

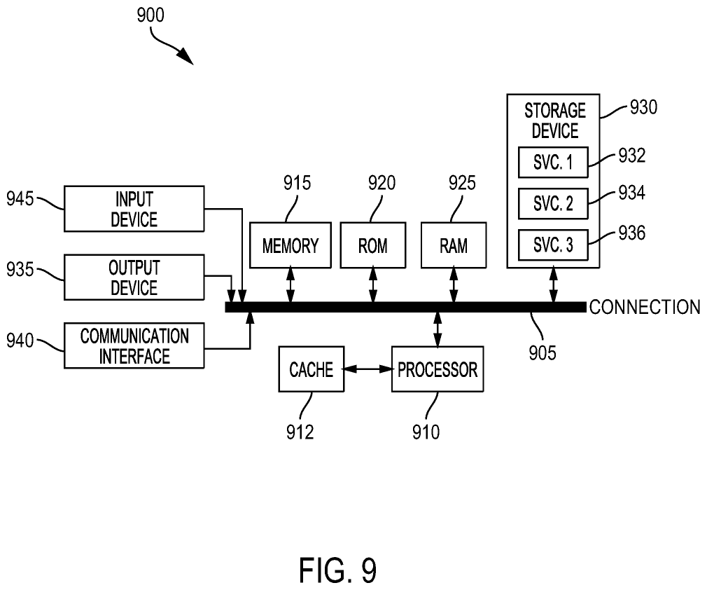

In the following disclosure, systems, methods, and computer-readable media are provided for transferring visual attributes to face verification images. The present technologies will be described in the following disclosure as follows. The discussion begins with a description of example systems, technologies and techniques for transferring visual attributes to face verification images, as illustrated in FIGS. 1 through 7. A description of an example method for transferring visual attributes to, and removing visual attributes from, face verification images as illustrated in FIG. 8, will then follow. The discussion concludes with a description of an example computing device architecture including example hardware components suitable for transferring facial visual attributes to images, as illustrated in FIG. 9. The disclosure now turns to FIG. 1.

FIG. 1 illustrates an example image processing system 100. The image processing system 100 can transfer visual attributes to face verification images and remove visual attributes from face verification images, as described herein. The image processing system 100 can obtain face verification images from one or more image capturing devices (e.g., cameras, image sensors, etc.) or synthetically generate face verification images. For example, in some implementations, the image processing system 100 can obtain a face verification image from an image capturing device, such as a single camera or image sensor device, and synthetically generate face verification images as described herein. The face verification images can refer to images capturing or depicting faces that can be used for facial recognition, verification, authentication, etc.

In the example shown in FIG. 1, the image processing system 100 includes an image sensor 102, a storage 108, compute components 110, encoders 120, generators 122 (or decoders), discriminators 124, an identifier 126, an authentication engine 128, and a rendering engine 130. The image processing system 100 can also optionally include another image sensor 104 and one or more other sensors 106, such as an audio sensor or a light emitting sensor. For example, in dual camera or image sensor applications, the image processing system 100 can include front and rear image sensors (e.g., 102, 104).

The image processing system 100 can be part of a computing device or multiple computing devices. In some examples, the image processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a television, a display device, a digital media player, a gaming console, a video streaming device, a drone, a computer in a car, an IoT (Internet-of-Things) device, a mobile computing device (e.g., a smartphone, a smart wearable, a tablet computer, etc.), or any other suitable electronic device(s).

In some implementations, the image sensor 102, the image sensor 104, the other sensor 106, the storage 108, the compute components 110, the encoders 120, the generators 122 (or decoders), the discriminators 124, the identifier 126, the authentication engine 128, and the rendering engine 130 can be part of the same computing device. For example, in some cases, the image sensor 102, the image sensor 104, the other sensor 106, the storage 108, the compute components 110, the encoders 120, the generators 122 (or decoders), the discriminators 124, the identifier 126, the authentication engine 128, and the rendering engine 130 can be integrated into a smartphone, laptop, tablet computer, smart wearable device, gaming system, and/or any other computing device. However, in some implementations, the image sensor 102, the image sensor 104, the other sensor 106, the storage 108, the compute components 110, the encoders 120, the generators 122 (or decoders), the discriminators 124, the identifier 126, the authentication engine 128, and the rendering engine 130 can be part of two or more separate computing devices.

The image sensors 102 and 104 can be any image and/or video sensors or capturing devices, such as a digital camera sensor, a video camera sensor, a smartphone camera sensor, an image/video capture device on an electronic apparatus such as a television or computer, a camera, etc. In some cases, the image sensors 102 and 104 can be part of a camera or computing device such as a digital camera, a video camera, an IP camera, a smartphone, a smart television, a game system, etc. In some examples, the image sensor 102 can be a rear image capturing device (e.g., a camera, video, and/or image sensor on a back or rear of a device) and the image sensor 104 can be a front image capturing device (e.g., a camera, image, and/or video sensor on a front of a device). In some examples, the image sensors 102 and 104 can be part of a dual-camera assembly. The image sensors 102 and 104 can capture image and/or video content (e.g., raw image and/or video data), which can then be processed by the compute components 110, the encoders 120, the generators 122 (or decoders), the discriminators 124, the identifier 126, the authentication engine 128, and/or the rendering engine 130, as described herein.

The other sensor 106 can be any sensor for detecting or measuring information such as sound, light, distance, motion, position, etc. Non-limiting examples of sensors include audio sensors, light detection and ranging (LIDAR) devices, lasers gyroscopes, accelerometers, and magnetometers. In one illustrative example, the sensor 106 can be an audio sensor configured to capture audio information, which can, in some cases, be used to supplement the face verification described herein. In some cases, the image processing system 100 can include other sensors, such as a machine vision sensor, a smart scene sensor, a speech recognition sensor, an impact sensor, a position sensor, a tilt sensor, a light sensor, etc.

The storage 108 can be any storage device(s) for storing data, such as image data (e.g., face verification images), security information, logs, mapping data, user data, etc. In some examples, the storage 108 can maintain a library or collection of face verification images. Moreover, the storage 108 can store data from any of the components of the image processing system 100. For example, the storage 108 can store data or measurements from any of the sensors 102, 104, 106, data from the compute components 110 (e.g., processing parameters, output images, calculation results, etc.), and/or data from any of the encoders 120, the generators 122, the discriminators 124, the identifier 126, the authentication engine 128, and/or the rendering engine 130 (e.g., output images, processing results, etc.). In some examples, the storage 108 can include a buffer for storing data (e.g., image data) for processing by the compute components 110.

In some implementations, the compute components 110 can include a central processing unit (CPU) 112, a graphics processing unit (GPU) 114, a digital signal processor (DSP) 116, and an image signal processor (ISP) 118. The compute components 110 can perform various operations such as face or user verification, face or user authentication, image generation, image enhancement, object or image segmentation, computer vision, graphics rendering, image/video processing, sensor processing, recognition (e.g., face recognition, text recognition, object recognition, feature recognition, tracking or pattern recognition, scene recognition, etc.), machine learning, filtering, visual attribute transfers, visual attribute removals, and any of the various operations described herein. In some examples, the compute components 110 can implement the encoders 120, the generators 122, the discriminators 124, the identifier 126, the authentication engine 128, and the rendering engine 130. In other examples, the compute components 110 can also implement one or more other processing engines.

The operations for the encoders 120, the generators 122, the discriminators 124, the identifier 126, the authentication engine 128, and the rendering engine 130 can be implemented by one or more of the compute components 110. In one illustrative example, the encoders 120, the generators 122, the discriminators 124, the identifier 126, and the authentication engine 128 (and associated operations) can be implemented by the CPU 112, the DSP 116, and/or the ISP 118, and the rendering engine 130 (and associated operations) can be implemented by the GPU 114. In some cases, the compute components 110 can include other electronic circuits or hardware, computer software, firmware, or any combination thereof, to perform any of the various operations described herein.

In some cases, the compute components 110 can receive data (e.g., image data, etc.) captured by the image sensor 102 and/or the image sensor 104, and process the data to generate face verification images, transfer one or more visual attributes to a face verification image, remove one or more visual attributes from a face verification image, etc. For example, the compute components 110 can receive image data (e.g., one or more frames, etc.) captured by the image sensor 102; detect or extract features and information (e.g., color information, texture information, semantic information, facial features, identity information, etc.) from the image data; remove one or more visual attributes detected in the image data and/or transfer one or more visual attributes from another image to that image; maintain and update a collection or library of face verification images; and perform face verification or authentication using the collection or library of face verification images, as described herein. An image or frame can be a red-green-blue (RGB) image or frame having red, green, and blue color components per pixel; a luma, chroma-red, chroma-blue (YCbCr) image or frame having a luma component and two chroma (color) components (chroma-red and chroma-blue) per pixel; or any other suitable type of color or monochrome picture.

The compute components 110 can implement the encoders 120 to map an image to a vector space with a certain dimensionality. For example, in some cases, the encoders 120 can map image data into a lower-dimensional code. The code can be a summary or compression of the image data, also called the latent-space representation. The compute components 110 can also implement the generators 122 or decoders, which can reconstruct an image using the code generated by the encoders 120.

The compute components 110 can also implement the discriminators 124. The discriminators 124 can be used to distinguish images, including images in a same or different visual attribute domain. Visual attribute domains can refer to categories or domains of visual features or attributes found on facial images. A facial image can refer to an image that captures or depicts a user's face and/or facial features. Non-limiting examples of visual attribute domains can include an eye glasses domain, a hair domain, a facial expression domain, a skin characteristics domain (e.g., makeup, tattoos, wrinkles, swelling, scars, bruising, redness, etc.), a contact lens domain, a facial hair domain (e.g., beard, mustache, eyebrows, etc.), a clothing or garment domain (e.g., hats, scarves, etc.), a specific background domain (e.g., color background, outdoors background, indoors background, daytime background, nighttime background, cluttered background, etc.), a noise domain, an occlusion domain, a brightness or color domain, a facial distortion domain (e.g., periorbital puffiness or swelling, facial edema, facial injury, dental conditions, etc.), and so forth.

In some examples, the discriminators 124 can distinguish between generated images (which contain visual attributes transferred from real images) from the real images that contain such visual attributes. For example, in some cases, the discriminators 124 can distinguish between fake images generated by the generators 122, which contain visual attributes transferred from real images, from the real images that contain such visual attributes. In some aspects, the discriminators 124 can distinguish between target images (e.g., facial images generated by the generators 122 to contain transferred attributes, facial images modified to include or exclude one or more features, etc.) generated in one visual attribute domain (e.g., eye glasses) and real images sampled from the same visual attribute domain. Moreover, in some cases, to distinguish between images, the discriminators 124 can extract features from images and compare the features to identify a match or mismatch between the images and/or extracted features.

The compute components 110 can implement the identifier 126 to detect identities of faces in facial images and compare the identities of faces in different facial images to determine whether the different facial images correspond to a same or different identity. The identifier 126 can thus compare identity information from different facial images and ensure consistency of identities between facial images before and after visual attribute transfers (e.g., source and target images, respectively) and/or between facial images associated with a same user. In some cases, the identifier 126 can detect features in images, generate feature vectors for the images based on the detected features, and determine a similarity between the feature vectors. The similarity can indicate whether the image associated with one feature vector corresponds to the same or different identity as another image associated with another feature vector.

In some cases, the compute components 110 can implement the authentication engine 128 to verify and/or authenticate user identities based on facial recognition or verification images generated and/or maintained by the image processing system 100. For example, the authentication engine 128 can obtain a facial image (which can be captured by the image sensor 102 and/or 104) of a user requesting authentication or verification, compare the facial image with one or more facial recognition or verification images maintained by the image processing system 100, and determine whether to verify or authenticate the user. In some cases, the authentication engine 128 can grant or deny user access to the image processing system 100 and/or a device associated with the image processing system 100 based on the facial verification or authentication results.

In some cases, the compute components 110 can also implement the rendering engine 130. The rendering engine 130 can perform operations for rendering content, such as images, videos, text, etc., for display on a display device. The display device can be part of, or implemented by, the image processing system 100, or can be a separate device such as a standalone display device or a display device implemented by a separate computing device. The display device can include, for example, a screen, a television, a computer display, a projector, and/or any other type of display device.

While the image processing system 100 is shown to include certain components, one of ordinary skill will appreciate that the image processing system 100 can include more or fewer components than those shown in FIG. 1. For example, the image processing system 100 can include, in some instances, one or more memory devices (e.g., RAM, ROM, cache, and/or the like), one or more networking interfaces (e.g., wired and/or wireless communications interfaces and the like), one or more display devices, and/or other hardware or processing devices that are not shown in FIG. 1. An illustrative example of a computing device and hardware components that can be implemented with the image processing system 100 is described below with respect to FIG. 9.

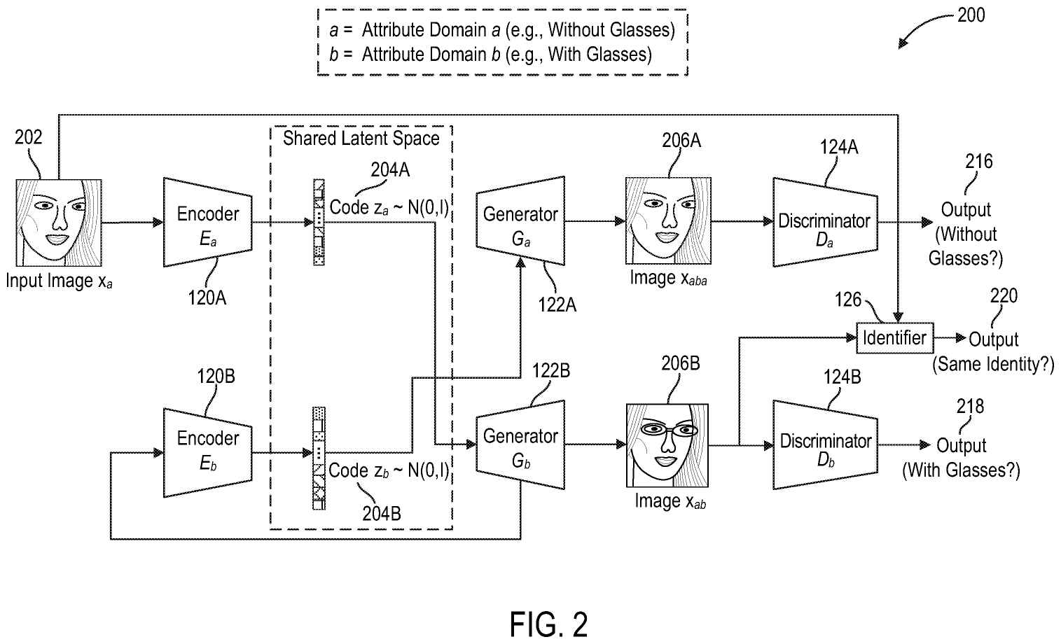

FIG. 2 illustrates an example system flow 200 for transferring visual attributes to images. In this example, the framework implements VAE-GANs. Each VAE-GAN combines a VAE and a GAN into an unsupervised generative model that can simultaneously learn to encode image data, generate (decode) image data, and compare dataset samples (e.g., image data). Thus, the VAE-GANs herein can include encoders, generators (decoders), and discriminators, which can be denoted as Eᵢ, Gᵢ, and Dᵢ, i ∈ {a, b}, where a and b refer to domain a and domain b. In the example shown in FIG. 2, domain a represents faces without eye glasses and domain b represents faces with eye glasses.

In addition, the example framework in system flow 200 includes an identifier I used to determine whether identity information in images match (e.g., whether the identities of the faces depicted in the images are the same) in order to ensure identity information between source images (e.g., images before a transfer or removal of one or more visual attributes) and target images (e.g., images after a transfer or removal of one or more visual attributes).

In FIG. 2, the system flow 200 shows an example process for transferring visual attributes from domain a (e.g., faces without eye glasses) to domain b (e.g., faces with eye glasses). However, in some cases, the VAE-GANs can be trained simultaneously for the opposite transfer, namely, from domain b to domain a. The VAE-GANs can be trained with image pairs from the two domains. It should be noted that domain a and domain b are used herein as illustrative examples for explanation purposes. In other cases, visual attributes can be transferred to or from different domains.

In this example, the image processing system 100 can first receive an input image 202 (Xₐ). The input image 202 can be a facial image in domain a (e.g., a face without eye glasses). For example, the input image 202 can be an image of a user's face without glasses captured by the image sensor 102.

The encoder 120A (Eₐ) can receive the input image 202 and can map the input image 202 from domain a to the means of code 204A (e.g., zₐ) in latent space z, which can be denoted E_{μ}(xₐ). Code 204A can represent a vector space with a certain dimensionality (e.g., a latent-space representation). Moreover, the encoder 120A, the code 204A, and the generator 122B (G_{b}) described below, can form a variable autoencoder (VAE) network, and the generator 122B and the discriminator 124B (D_{b}), further described below, can form a GAN. Thus, the encoder 120A, the code 204A, the generator 122B and the discriminator 124B together can form a VAE-GAN.

Similarly, the encoder 120B, the code 204B, and the generator 122A (Gₐ) described below, can form another VAE network, and the generator 122A and the discriminator 124A (Dₐ), further described below, can form another GAN. Thus, the encoder 120B, the code 204B, the generator 122A and the discriminator 124A together can form another VAE-GAN.

In some cases, each component of code 204A (zₐ) in latent space z can be conditionally independent and can have a Gaussian distribution (e.g., N(0, I)) with unit variance. Moreover, the code 204A (zₐ), which can be randomly sampled from latent space z, can be used by generator 122B (G_{b}) to reconstruct the input image 202 (Xₐ). Since random code sampling from the latent space is not differentiable, reparameterization can be used so that the VAE can be trained via backpropagation.

As previously mentioned, components in the latent space can be independent and follow normal distributions with zero mean and unit variance. Thus, in some implementations, instead of sampling code 204A (zₐ) from the latent space, the code 204A (zₐ) can be defined using a function of η and (μ, I) as ·I, where η˜N(0, I) and (μ, I) represent the mean and variance of normal distributions approximating the distributions of components in the latent space. Therefore, the encoder 120A can map images to the mean of latent codes, and codes randomly sampled from the latent space can be expressed as zₐ=μₐ+η. Similarly, the encoder 120B described below can map images to the mean of latent codes, and codes randomly sampled from the latent space can be expressed as z_{b}=μ_{b})+η.

The code 204A generated by the encoder 120A can be fed into a generator 122B (G_{b}) or decoder in domain b. The generator 122B can map code 204A in the latent space of domain a to target image 206B (x_{ab}) in domain b. Thus, the generator 122B can generate a synthetic image (e.g., target image 206B) in domain b based on the code 204A. In some implementations, a last layer of the generator 122B can use a hyperbolic tangent (tanh) function as an activation function to ensure that the intensity values of images generated by the generator 122B (e.g., target image 206B) are normalized between 0 and 1.

The target image 206B can be generated to include facial features from the input image 202 as well as visual attributes (e.g., eye glasses) transferred from one or more images in domain b (e.g., one or more images of faces with eye glasses). The one or more images can be, for example, sample images (e.g., a sample dataset) depicting faces with eye glasses. In some cases, the sample images can be used to train the generator 122B to properly detect eye glasses and/or transfer eye glasses from the sample images to the images generated by the generator 122B (e.g., target image 206B).

Moreover, the sample images can be fed into the discriminator 124B (D_{b}) in domain b along with the target image 206B. In some cases, the goal of the generator 122B can be to fool or trick the discriminator 124B into recognizing the synthetic image generated by the generator 122B (e.g., target image 206B) as authentic, and the goal of the discriminator 124B can be to recognize the images generated by the generator 122B as fake. In some cases, the goal of the generator 122B can be to generate realistic synthetic images with specific visual attributes transferred from one or more other images, and the goal of the discriminator 124B can be to recognize such visual attributes.

In some implementations, the generator 122B can feed the target image 206B back to encoder 120B (E_{b}) in domain b. The encoder 120B can use the target image 206B to generate a code 204B (z_{b}) in latent space z. Moreover, the encoder 120B can provide the code 204B to generator 122A in domain a, which can use the code 204B to generate target image 206A (x_{aba}) in domain a. The target image 206A can be a synthetic image generated by the generator 122A through an inverse transfer of the visual attributes transferred to the target image 206B. For example, after a transfer of visual attributes to the input image 202, the generator 122B generates target image 206B (x_{ab}). In the process of the inverse transfer, the generator 122A with an input of a code 204B (z_{b}) in latent space z can aim to generate the image (206A) so that it remains the same as the input image 202. Thus, at this point in system flow 200, generator 122A can have generated a target image 206A in domain a, which does not include eye glasses, and generator 122B can have generated a target image 206B in domain b, which includes eye glasses.

The discriminator 124A in domain a can be used to distinguish between target image 206A in domain a and one or more images sampled in domain a. The discriminator 124A can generate a discrimination output 216 which can specify whether the target image 206A without the visual attributes (e.g., glasses) is sampled from real images in domain a. In some examples, the discriminator 124A can output true for images sampled in domain a, and false for the target image 206A generated by the generator 122A. In some cases, the goal of the generator 122A can be to fool or trick the discriminator 124A into recognizing the synthetic image generated by the generator 122A (e.g., target image 206A) as authentic, and the goal of the discriminator 124A can be to recognize the images generated by the generator 122A as fake. In some cases, the goal of the generator 122A can be to generate realistic synthetic images with specific visual attributes transferred from one or more other images, and the goal of the discriminator 124A can be to distinguish images with such synthetic visual attributes from real ones.

As previously noted, the discriminator 124B (D_{b}) in domain b can be used to distinguish between target image 206B in domain b and one or more images sampled in domain b. The discriminator 124B (D_{b}) can generate an output 218 specifying whether the target image 206B with the visual attributes (e.g., glasses) is sampled from real images in domain b. In some examples, the discriminator 124B can output true for any images sampled in domain b, and false for the target image 206B generated by the generator 122B.

Moreover, training the GAN represented by the concatenation of generator 122B and discriminator 124B, can enable the generator 122B to generate the target image 206B (x_{ab}) so as to fool or confuse the discriminator 124B into recognizing the target image 206B as authentic and can make the target image 206B appear as if it is an image from the sample images in domain b. As previously noted, the goal of the generator 122B can be to fool or trick the discriminator 124B into recognizing the synthetic image generated by the generator 122B (e.g., target image 206B) as authentic, and the goal of the discriminator 124B can be to recognize the images generated by the generator 122B as fake.

Similarly, training the GAN represented by the concatenation of generator 122A and discriminator 124A, can enable the generator 122A to generate the target image 206A (x_{aba}) (which can be referred to as a target image 206A) so as to fool or confuse the discriminator 124A into recognizing the target image 206A as authentic and can make the target image 206A appear as if it is an image from the sample images in domain a.

When processing the target image 206B, the discriminator 124B can extract features from the target image 206B and analyze the extracted features to attempt to distinguish the target image 206B from sample images in domain b. Likewise, when processing the target image 206A, the discriminator 124A can extract features from the target image 206A and analyze the extracted features to attempt to distinguish the target image 206A from sample images in domain a.

As previously explained, the transferring of visual attributes from domain a to domain b can be implemented by the concatenation of encoder 120A (Eₐ), generator 122B (G_{b}), and discriminator 124B (D_{b}). In contrast, the opposite transfer of visual attributes (e.g., from domain b to domain a) can be implemented by the concatenation of encoder 120B (E_{b}), generator 122A (Gₐ), and discriminator 124A (Dₐ). In some examples, these two subnetworks can be isolated. Moreover, given an assumption that high-level features of images should be consistent, images in domains a and b may share the same latent space z, which can be a junction that combines these two subnetworks.

Since codes 204A (zₐ) and 204B (z_{b}) are generated by encoders 120A (Eₐ) and 120B (E_{b}) separately, a cycle consistency constraint can be used to allocate them into the same latent space z. This can be accomplished by mapping the target image 206B (x_{ab}) to code 204B (z_{b}). Since codes 204A (zₐ) and 204B (z_{b}) are in the same latent space, the two codes can be interchangeable. Therefore, when code 204B (z_{b}) is passed through the GAN in domain a formed by generator 122A and discriminator 124A, the corresponding output target image 206A (x_{aba}) can also be in the domain a. This process illustrates how the cycle consistency constraint can be implemented.

With cycle consistency, the two subnetworks mentioned above can be combined and trained simultaneously. However, without a constraint on the identity of faces captured by the target face image (e.g., target image 206B) and the source image (e.g., input image 202), the target face image could, in some cases, have a different identity than the source image. Therefore, an identifier 126 (I) can be implemented to verify and maintain a consistent identity between images. The identifier 126 can verify that the facial identity in the images (e.g., input image 202 and target image 206B) is consistent by extracting features from the images and comparing the extracted features. The identifier 126 can generate an output 220 indicating whether the facial identities in the images 202 and 206B are the same.

In some examples, the identifier 126 can select dominant features between two feature vectors associated with the images (e.g., input image 202 and target image 206B), and remove or limit noise in the image data. In some implementations, the identifier 126 can generate a feature vector with a certain dimension (e.g., 256 or any other dimension). The identifier 126 can compare the feature vectors of the source and target images (e.g., input image 202 and target image 206B respectively) using, for example, cosine distance. A lower distance can correspond to a higher similarity, which ensures identity consistency, and a higher distance can indicate a lower similarity, which indicates a lack of or limited identity consistency.

When training the network (e.g., the VAE-GANs), two loss functions, which correspond to the GANs and VAEs respectively, can be optimized. Since the network has a symmetric structure, the loss functions of the corresponding GANs and VAEs can be similar. In some examples, the loss functions for the GANs can be as follows:

$$\begin{matrix}{ℒ}_{{GAN}_{a}} ( {D}_{a} ) = {λ}_{0} [ {𝔼}_{{x}_{a} ∼ {P}_{{x}_{a}}} {‖ {D}_{a} ( {x}_{a} ) - 1 ‖}_{2}^{2} + {𝔼}_{{z}_{b} ∼ {q}_{b} ( {z}_{b} \vert {x}_{b} )} {‖ {D}_{a} ( {G}_{a} ( {z}_{b} ) ) - 0 ‖}_{2}^{2} ] , & Equation ( 1 ) \\ {ℒ}_{{GAN}_{b}} ( {D}_{b} ) = {λ}_{0} [ {𝔼}_{{x}_{b} ∼ {P}_{{x}_{b}}} {‖ {D}_{b} ( {x}_{b} ) - 1 ‖}_{2}^{2} + {𝔼}_{{z}_{a} ∼ {q}_{a} ( {z}_{a} \vert {x}_{a} )} {‖ {D}_{b} ( {G}_{b} ( {z}_{a} ) ) - 0 ‖}_{2}^{2} ] . & Equation ( 2 )\end{matrix}$$

where Pxₐ and Px_{b} correspond to the distributions of real images in domains a and b, respectively, and λ₀ is the weight for the loss functions of the GANs. Moreover, when training the GANs, in some examples, only fake images decoded from cross-domain latent codes are considered. The distributions of such latent codes can be denoted as q_{b} (z_{b}|x_{b}) and qₐ (zₐ|xₐ), respectively.

In some cases, since VAEs are responsible for image reconstruction in each domain, the generators (122A, 122B) of the GANs may force only fake images synthesized from cross-domain codes to confuse the discriminators (124A, 124B). Therefore, in some examples, the loss functions of the generators 122A and 122B can be as follows:

[symbol]

_{GAN}_{ₐ}(Gₐ)=λ₁∥Dₐ(Gₐ(z_{b}))−1∥_{2′}² Equation (3)

[symbol]

_{GAN}_{ₐ}(G_{b})=λ₁∥D_{b}(G_{b}(zₐ))−1∥_{2′}² Equation (4)

In some examples, the loss functions for the VAEs can include a component that penalizes the deviation of the distribution of codes (e.g., 204A, 204B) in the latent space from the prior distribution, which can be a zero mean Gaussian, n˜N(0, I), and a component that penalizes the reconstruction loss between the source image (e.g., 202) and the one generated by the corresponding generator (e.g., 122A or 122B). Example loss functions for the VAEs can be as follows:

[symbol]

_{VAE}_{ₐ}(Eₐ, Gₐ)=λ₂KL(qₐ(zₐ|xₐ)∥p_{η}(z))+λ₃∥x′ₐ−xₐ∥₁ Equation (5)

[symbol]

_{VAE}_{_{b}}(E_{b}, G_{b})=λ₂KL(q_{b}(z_{b}|x_{b})∥p_{η}(z))+λ₃∥x′_{b}−x_{b}∥₁ Equation (6)

where x′ₐ and x′_{b} are images reconstructed by generators 122A (Gₐ) and 122B (G_{b}) from latent codes 204A (zₐ) and 204B (z_{b}), respectively.

With the cycle consistency constraint, the two VAEs can be combined. Therefore, in the training process, additional penalties from the cycle consistency constraint can be added to the VAE loss functions. In some cases, one example penalty can utilize an assumption that, in the latent space, the high-level representations of source and target images (e.g., input image 202, target image 206A, target image 206B) are similar. Therefore, the deviation of the distribution of codes for target images from the prior distribution can be penalized. In some cases, another example penalty can pertain to the difference between the source image and the image reconstructed from the target image (e.g., target image 206A or target image 206B). An example of updated VAE loss functions can be as follows:

[symbol]

_{VAE}_{ₐ}(Eₐ, Gₐ, E_{b}, G_{b})=λ₂KL(qₐ(zₐ|xₐ)∥p_{η}(z))+λ₃∥x′ₐ−xₐ∥₁+λ₄KL(q_{b}(z_{b}|x_{ab})∥p_{η}(z))+λ₅∥x_{aba}−xₐ∥₁, Equation (7)

[symbol]

_{VAE}_{_{b}}(E_{b}, G_{b}, Eₐ, Gₐ)=λ₂KL(q_{b}(z_{b}|x_{b})∥p_{η}(z))+λ₃∥x′_{b}−x_{b}∥₁+λ₄KL(qₐ(zₐ|x_{ba})∥p_{η}(z))+λ₅∥x_{bab}−x_{b}∥₁, Equation (8)

where λ₂ and λ₃ are the weights on the losses of KL divergence, respectively.

In addition to these loss items, constraints on target images 206B (x_{ab}) and 206A (x_{aba}) can derive other loss items. For example, one loss item can ensure that target images (e.g., 206A, 206B) belong to the target domain (e.g., domain a, domain b). Another example loss item can ensure that source and target images (e.g., input image 202, target image 206A, target image 206B) have the same identity. An example of such loss function for the VAEs can be as follows:

[symbol]

_{I}=λ₆(1−cos(I(xₐ)·I(x_{ab}))), Equation (9)

where I(·) represents the output feature vector from the identifier 126 (I) with a dimension of 256. In some examples, the parameters λ₀ through λ₆ can have values of 1, 1, 0.01, 10, 0.01, 10, 1, respectively. In other examples, the parameters λ₀ through λ₆ can have other values.

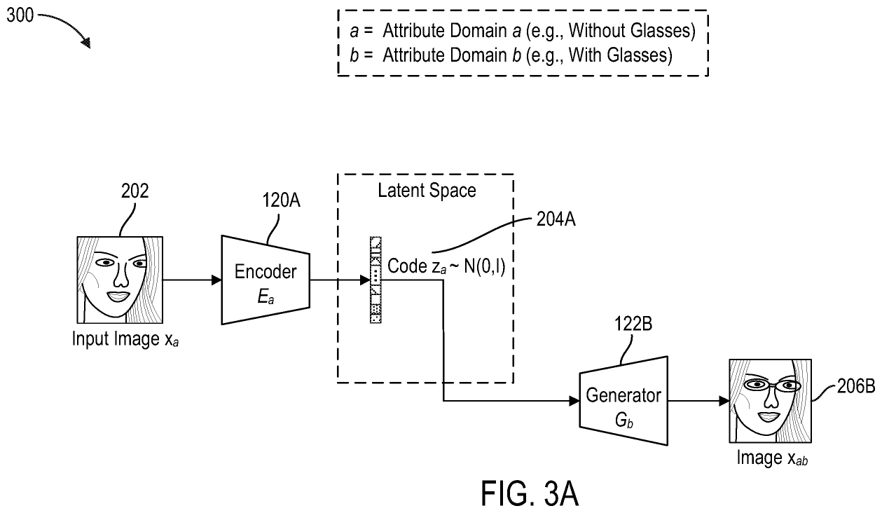

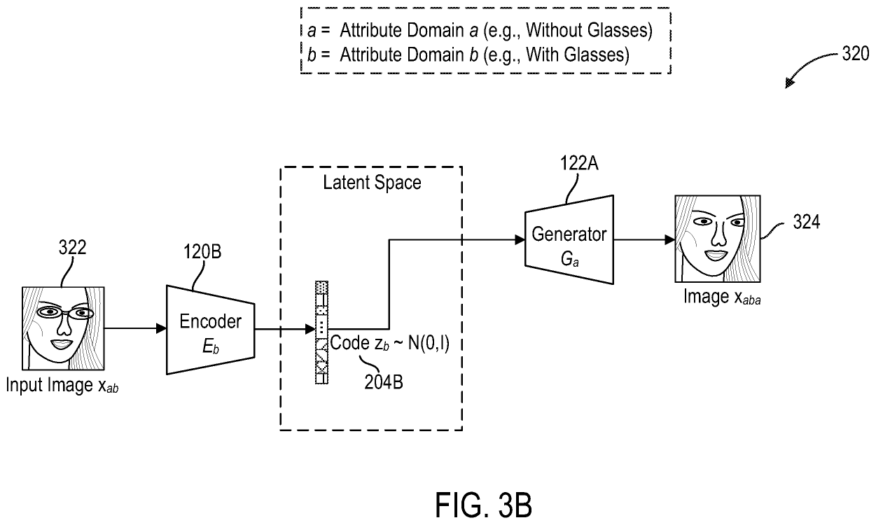

FIG. 3A illustrates another example system flow 300 for transferring visual attributes in one example attribute domain (e.g., domain a) to an image (e.g., target image 206B) in another attribute domain (e.g., domain b). In some cases, the system flow 300 can be implemented in a testing scenario to produce and test a synthetic image in one domain, which includes one or more visual attributes transferred from one or more images in another domain. In other cases, the system flow 300 can be implemented as part of an image verification enrollment process. For example, the system flow 300 can be implemented when a user enrolls an image for image verification, to create synthetic versions of the image with one or more visual attributes transferred or added from another domain. In yet other cases, the system flow 300 can be implemented during a facial verification or authentication procedure to generate facial verification images with transferred visual attributes.

In this example system flow, the encoder 120A (Eₐ) can first receive the input image 202 (Xₐ) and map the input image 202 from domain a to the means of code 204A (e.g., zₐ) in the latent space z. The code 204A generated by the encoder 120A can then be fed into the generator 122B (G_{b}) in domain b. The generator 122B can map code 204A in the latent space of domain a to target image 206B (x_{ab}) in domain b. Thus, the generator 122B can generate a synthetic image (e.g., target image 206B) in domain b based on the code 204A.

The target image 206B can be generated to include the facial features from the input image 202 as well as visual attributes (e.g., eye glasses) transferred from one or more images in domain b (e.g., one or more images of faces with eye glasses). The one or more images can be, for example, sample images (e.g., a sample dataset) depicting faces with eye glasses. In some cases, the sample images can be used to train the generator 122B to properly detect eye glasses and/or transfer eye glasses from the sample images to the images generated by the generator 122B (e.g., target image 206B). The goal of the generator 122B is to generate a synthetic image in domain b (e.g., target image 206B) that appears authentic.

FIG. 3B illustrates another example system flow 320 for removing visual attributes in one example attribute domain (e.g., domain b) from an image (e.g., 324) in another attribute domain (e.g., domain a). In some cases, the system flow 320 can be implemented in a testing scenario to produce and test a synthetic image in one domain, which has removed one or more visual attributes from another domain. In other cases, the system flow 320 can be implemented as part of an image verification enrollment process. For example, the system flow 320 can be implemented when a user enrolls an image from one domain for image verification, to create synthetic versions of the image with one or more visual attributes removed. In yet other cases, the system flow 320 can be implemented during a facial verification or authentication procedure to generate facial verification images with one or more visual attributes removed.

In this example system flow, the encoder 120B (E_{b}) can first receive the image 322 (X_{ab}) in domain b, and map the image 322 from domain b to the means of code 204B (e.g., z_{b}) in the latent space z. The code 204B generated by the encoder 120B can then be fed into the generator 122A (Gₐ) in domain a. The generator 122A can map code 204B in the latent space of domain b to image 324 (x_{aba}) in domain a. Thus, the generator 122A can generate a synthetic image (e.g., image 324) in domain a based on the code 204B.

The image 324 can be generated to include facial features from the input image 322 and remove one or more visual attributes (e.g., eye glasses) from the input image 322 in domain b. The goal of the generator 122A is to generate a synthetic image in domain a (e.g., image 324) that appears authentic.

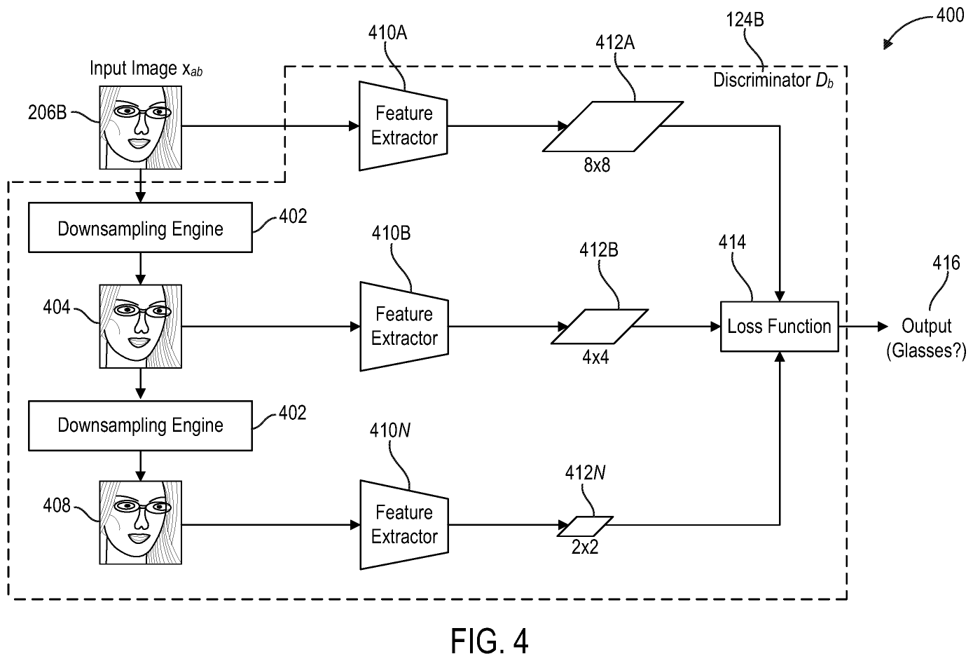

FIG. 4 is a diagram of an example configuration 400 of discriminator 124B used to distinguish images. While the configuration 400 in this example illustrates discriminator 124B, it should be noted that the configuration 400 can similarly apply to discriminator 124A. Moreover, the configuration 400 depicts an example system flow that can be implemented by discriminator 124B, as well as an example multi-scale structure of discriminator 124B. The multi-scale structure of the discriminator 124B in the example configuration 400 can include multiple features extractors 410A-N, as illustrated in FIG. 4.

In the system flow of the discriminator 124B in the example configuration 400, the discriminator 124B can first receive target image 206B (X_{ab}), which can be an image in domain b as previously explained. The target image 206B is fed into feature extractor 410A, which can analyze the target image 206B to extract features in the target image 206B. The feature extractor 410A can then output a feature map 412A of a certain size. In this illustrative example, the feature map 412A is 8×8. However, other feature map sizes are also contemplated herein. The feature map 412A is the fed to the loss function 414 implemented by the discriminator 124B.

In addition, the discriminator 124B can use a downsampling engine 402 downsample the target image 206B to reduce its size. In some examples, the discriminator 124B can downsample the target image 206B by average pooling. Moreover, in some examples, the average pooling can be strided. For example, in some cases, the discriminator 124B can downsample the target image 206B by average pooling with a stride of 2. The downsampling of the target image 206B can produce a downsampled image 404, which can then be fed to feature extractor 410B.

The feature extractor 410B can analyze the downsampled image 404 and extract features from it. The feature extractor 410B can then output a feature map 412B of a certain size, which can be different than the size of the feature map 412A generated by the feature extractor 410A. In this illustrative example, the feature map 412B is 4×4. However, other feature map sizes are also contemplated herein. Moreover, like the feature map 412A produced by the feature extractor 410A, the feature map 412B produced by the feature extractor 410B can then be fed into the loss function 414.

The discriminator 124B can use the downsampling engine 402 to further downsample the downsampled image 404 to further reduce its size. In some examples, the discriminator 124B can downsample the downsampled image 404 by average pooling. Moreover, in some examples, the average pooling can be strided. For example, in some cases, the discriminator 124B can downsample the downsampled image 404 by average pooling with a stride of 2. The downsampling of the downsampled image 404 can produce another downsampled image 408, which can then be fed to feature extractor 410N.

The feature extractor 410N can analyze the downsampled image 408 and extract features from it. The feature extractor 410N can then output a feature map 412N of a certain size, which can be different than the size of the feature map 412A generated by the feature extractor 410A and the feature map 412B generated by the feature extractor 410B. In this illustrative example, the feature map 412N is 2×2. However, other feature map sizes are also contemplated herein. Moreover, like the feature map 412A produced by the feature extractor 410A, the feature map 412N produced by the feature extractor 410N can then be fed into the loss function 414.

The discriminator 124B can apply the loss function 414 to the feature map 412A from feature extractor 410A, the feature map 412B from feature extractor 410B, and the feature map 412N from feature extractor 410N. In some examples, the loss function 414 can be a least squares loss function. The loss function 414 can then output a result 416. In some examples, the result 416 can be a binary or probabilities output such as [true, false] or [0, 1]. Such output (e.g., result 416) can, in some cases, provide a classification or discrimination decision. For example, in some cases, the output (result 416) can recognize or classify the target image 206B as having certain visual attributes. To illustrate, the output (result 416) can indicate whether the target image 206B (or the face depicted in the target image 206B) includes eye glasses (e.g., true or 1) or not (e.g., false or 0).

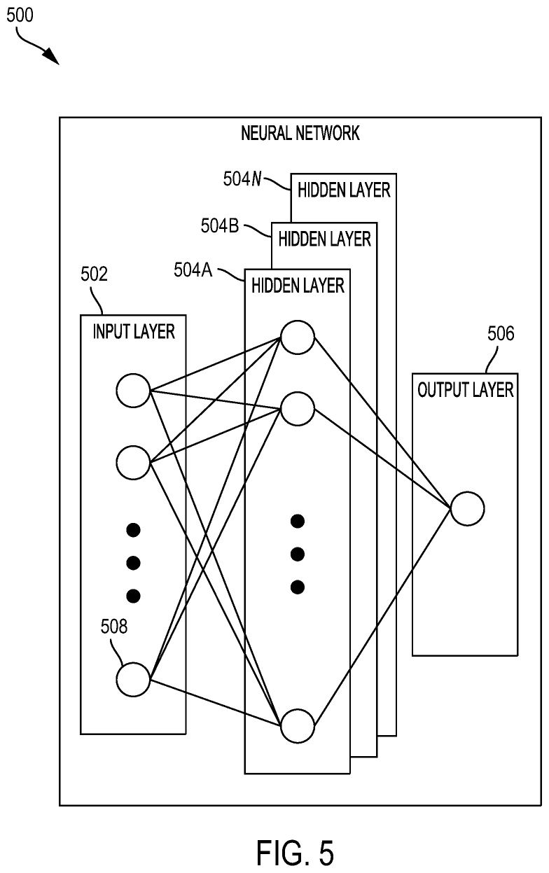

FIG. 5 illustrates an example configuration of a neural network 500 that can be implemented by one or more components in the VAE-GANs, such as the encoders 120A-B, the generators 122A-B, the discriminators 124A-B, the identifier 126, the feature extractors 410A-N (collectively “410”), etc. For example, the neural network 500 can be implemented by the encoders 120A-B to generate codes 204A-B from an input image (e.g., 202), the generators 122A-B to generate synthetic images with transferred or removed attributes, the discriminators 124A-B to generate a discrimination result, the identifier 126 to generate an identification result, the feature extractors 410 to extract features from images, etc.

The neural network 500 includes an input layer 502, which includes input data. In one illustrative example, the input data at input layer 502 can include image data (e.g., input image 202). The neural network 500 further includes multiple hidden layers 504A, 504B, through 504N (collectively “504” hereinafter). The neural network 500 can include “N” number of hidden layers (504), where “N” is an integer greater or equal to one. The number of hidden layers can include as many layers as needed for the given application.

The neural network 500 further includes an output layer 506 that provides an output resulting from the processing performed by the hidden layers 504. For example, the output layer 506 can provide a code or latent-space representation, a synthetic image, a discrimination result, an identification result, a feature extraction result, a classification result, etc.

The neural network 500 is a multi-layer neural network of interconnected nodes. Each node can represent a piece of information. Information associated with the nodes is shared among the different layers (502, 504, 506) and each layer retains information as it is processed. In some examples, the neural network 500 can be a feed-forward network, in which case there are no feedback connections where outputs of the network are fed back into itself. In other examples cases, the neural network 500 can be a recurrent neural network, which can have loops that allow information to be carried across nodes while reading in input.

Information can be exchanged between nodes in the layers (502, 504, 506) through node-to-node interconnections between the layers (502, 504, 506). Nodes of the input layer 502 can activate a set of nodes in the first hidden layer 504A. For example, as shown, each of the input nodes of the input layer 502 is connected to each of the nodes of the first hidden layer 504A. The nodes of the hidden layers 504 can transform the information of each input node by applying activation functions to the information. The information derived from the transformation can then be passed to, and activate, the nodes of the next hidden layer 504B, which can perform their own designated functions. Example functions include, without limitation, convolutional, up-sampling, down-sampling, data transformation, and/or any other suitable functions. The output of the hidden layer 504B can then activate nodes of the next hidden layer, and so on. The output of the last hidden layer 504N can activate one or more nodes of the output layer 506, which can then provide an output. In some cases, while nodes (e.g., 508) in the neural network 500 are shown as having multiple output lines, a node has a single output and all lines shown as being output from a node represent the same output value.

In some cases, each node or interconnection between nodes can have a weight that is a set of parameters derived from a training of the neural network 500. For example, an interconnection between nodes can represent a piece of information learned about the interconnected nodes. The interconnection can have a numeric weight that can be tuned (e.g., based on a training dataset), allowing the neural network 500 to be adaptive to inputs and able to learn as more and more data is processed.

In some cases, the neural network 500 can be pre-trained to process the data in the input layer 502 using the different hidden layers 504 in order to provide the output through the output layer 506. The neural network 500 can be further trained as more input data, such as image data, is received. In some cases, the neural network 500 can be trained using unsupervised learning. In other cases, the neural network 500 can be trained using supervised and/or reinforcement training. As the neural network 500 is trained, the neural network 500 can adjust the weights and/or biases of the nodes to optimize its performance.

In some cases, the neural network 500 can adjust the weights of the nodes using a training process such as backpropagation. Backpropagation can include a forward pass, a loss function, a backward pass, and a weight update. The forward pass, loss function, backward pass, and parameter update is performed for one training iteration. The process can be repeated for a certain number of iterations for each set of training data (e.g., image data) until the weights of the layers 502, 504, 506 in the neural network 500 are accurately tuned.

To illustrate, in an example where neural network 500 is configured to detect features in an image, the forward pass can include passing image data samples through the neural network 500. The weights may be initially randomized before the neural network 500 is trained. For a first training iteration for the neural network 500, the output may include values that do not give preference to any particular feature, as the weights have not yet been calibrated. With the initial weights, the neural network 500 may be unable to detect some features and thus may yield poor detection results for some features. A loss function can be used to analyze error in the output. Any suitable loss function definition can be used. One example of a loss function includes a mean squared error (MSE). The MSE is defined as Eₜₒₜₐₗ=Σ½(target−output)², which calculates the sum of one-half times the actual answer minus the predicted (output) answer squared. The loss can be set to be equal to the value of Eₜₒₜₐₗ.

The loss (or error) may be high for the first training image data samples since the actual values may be much different than the predicted output. The goal of training can be to minimize the amount of loss for the predicted output. The neural network 500 can perform a backward pass by determining which inputs (weights) most contributed to the loss of the neural network 500, and can adjust the weights so the loss decreases and is eventually minimized

A derivative of the loss with respect to the weights (denoted as dL/dW, where W are the weights at a particular layer) can be computed to determine the weights that most contributed to the loss of the neural network 500. After the derivative is computed, a weight update can be performed by updating all the weights of the filters. For example, the weights can be updated so they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 500 can include any suitable neural network. One example includes a convolutional neural network (CNN), which includes an input layer and an output layer, with multiple hidden layers between the input and output layers. The hidden layers of a CNN include a series of convolutional/deconvolutional, nonlinear, pooling, fully connected normalization, and/or any other layers. The neural network 500 can include any other deep network, such as an autoencoder (e.g., a variable autoencoder, etc.), a deep belief nets (DBNs), a recurrent neural networks (RNNs), a residual network (ResNet), a GAN, an encoder network, a decoder network, among others.

In some examples, the encoders 120A-B can implement a neural network (500) with a structure having the following illustrative sequence of layers depicted in Table 1:

TABLE 1

| | | | | Kernel | | | |
|---|---|---|---|---|---|---|---|
| Input | Operator | Channels | Repeated | Size | Stride | Normalization | Activation |
| 128² × 1 | conv2d | 64 | 1 | 7 | 1 | IN | ReLU |
| 128² × 64 | conv2d | 128 | 1 | 4 | 2 | IN | ReLU |
| 64² × 128 | conv2d | 256 | 1 | 4 | 2 | IN | ReLU |
| 32² × 256 | resnet | 256 | 4 | 3 | 1 | IN | ReLU |

In Table 1, “Input” refers to the size or resolution of an input image at each layer, “Operator” refers to the type of operation (e.g., 2D convolution, ResNet, etc.) at each layer, “Channels” refers to a number of output channels at each layer, “Repeated” refers to a number of repetitions of each operator, “Kernel Size” refers to the kernel size at each layer, “Stride” refers to the amount by which a filter or kernel shifts at each layer, “Normalization” refers to a type (if any) of normalization implemented at each layer, and “Activation” refers to the activation function at each layer. Moreover, “IN” refers to instance normalization, and “ReLU” refers to a rectified linear unit activation function.

In some examples, the generators 122A-B can implement a neural network (500) with a structure having the following illustrative sequence of layers depicted in Table 2:

TABLE 2

| | | | | Kernel | | | |
|---|---|---|---|---|---|---|---|
| Input | Operator | Channels | Repeated | Size | Stride | Normalization | Activation |
| 32² × 256 | resnet | 256 | 4 | 3 | 1 | IN | ReLU |
| 32² × 256 | dconv2d | 128 | 1 | 5 | 1 | LN | ReLU |
| 64² × 128 | dconv2d | 64 | 1 | 5 | 1 | LN | ReLU |
| 128² × 64 | dconv2d | 1 | 1 | 7 | 1 | none | sigmoid |

In Table 2, “dconv2d” refers to a 2D deconvolution, “LN” refers to layer normalization, and “tank” refers to a sigmoid function.

In some examples, the feature extractors 410 can implement a neural network (500) with a structure having the following illustrative sequence of layers depicted in Table 3:

TABLE 3

| | | | | Kernel | | | |
|---|---|---|---|---|---|---|---|
| Input | Operator | Channels | Repeated | Size | Stride | Normalization | Activation |
| 128² × 1 | conv2d | 64 | 1 | 4 | 2 | none | LReLU |
| 64² × 64 | conv2d | 128 | 1 | 4 | 2 | none | LReLU |
| 32² × 128 | conv2d | 256 | 1 | 4 | 2 | none | LReLU |
| 16² × 256 | conv2d | 512 | 1 | 4 | 2 | none | LReLU |
| 8² × 512 | conv2d | 1 | 1 | 1 | 1 | none | none |

Moreover, in some examples, the identifier 126 can implement a neural network (500) with a structure having the following illustrative sequence of layers depicted in Table 4:

TABLE 4

| | | | | Kernel | | | |
|---|---|---|---|---|---|---|---|
| Input | Operator | Channels | Repeated | Size | Stride | Normalization | Activation |
| 128² × 1 | conv2d | 64 | 1 | 3 | 2 | none | PReLU |
| 64² × 64 | conv2d | 64 | 2 | 3 | 1 | none | PReLU |
| 64² × 64 | conv2d | 128 | 1 | 3 | 2 | none | PReLU |
| 32² × 128 | conv2d | 128 | 4 | 3 | 1 | none | PReLU |
| 32² × 128 | conv2d | 256 | 1 | 3 | 2 | none | PReLU |
| 16² × 256 | conv2d | 256 | 8 | 3 | 1 | none | PReLU |
| 16² × 256 | conv2d | 512 | 1 | 3 | 1 | none | PReLU |
| 8² × 512 | conv2d | 512 | 2 | 3 | 1 | none | PReLU |
| 8² × 512 | FC | 512 | 1 | 1 | 1 | none | none |
| 512 | MFM | 256 | 1 | N/A | N/A | none | none |

In Table 4, “FC” refers to fully connected layers, “MFM” indicates a layer of Max-Feature-Max which can help the identifier 126 select dominant features between feature vectors and reduce the influence of noise, and “PReLU” represents a parametric ReLU function.

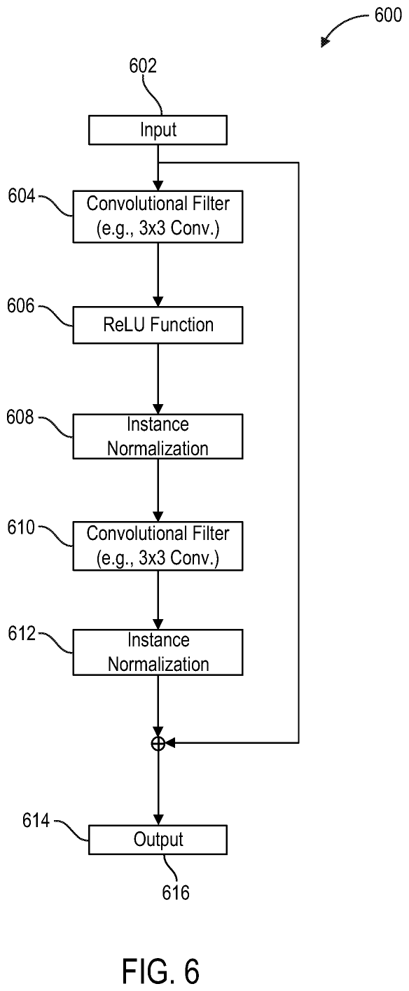

FIG. 6 illustrates an example configuration of a residual network (ResNet) model 600 that can be implemented by an encoder (e.g., 120A, 120B) when mapping input image data to a vector space or code of a certain dimensionality. The ResNet model 600 can perform residual learning, where instead of learning features at the end of a network's layers, the network learns a residual. The residual can be understood as a subtraction of features learned from the input of a layer.

In this example, the ResNet model 600 receives an input 602 (e.g., image data) which is passed through a convolutional layer 604. In some examples, the convolutional layer 604 can apply 2D convolutions, such as 3×3 convolutions, on the input 602.

The ResNet model 600 then applies a ReLU activation function 606 to the data generated by the convolutional layer 604, such as a feature map generated by the convolutional layer 604. The ResNet model 600 then performs instance normalization 608 on the output of the ReLU activation function 606, and the result is passed through another convolutional layer 610, which can perform convolutions such as 3×3 convolutions.

The ResNet model 600 normalizes 612 the result from the convolutional layer 610 using instance normalization, and multiplies 614 the output with the input 602 to generate an output 616 for the ResNet model 600.

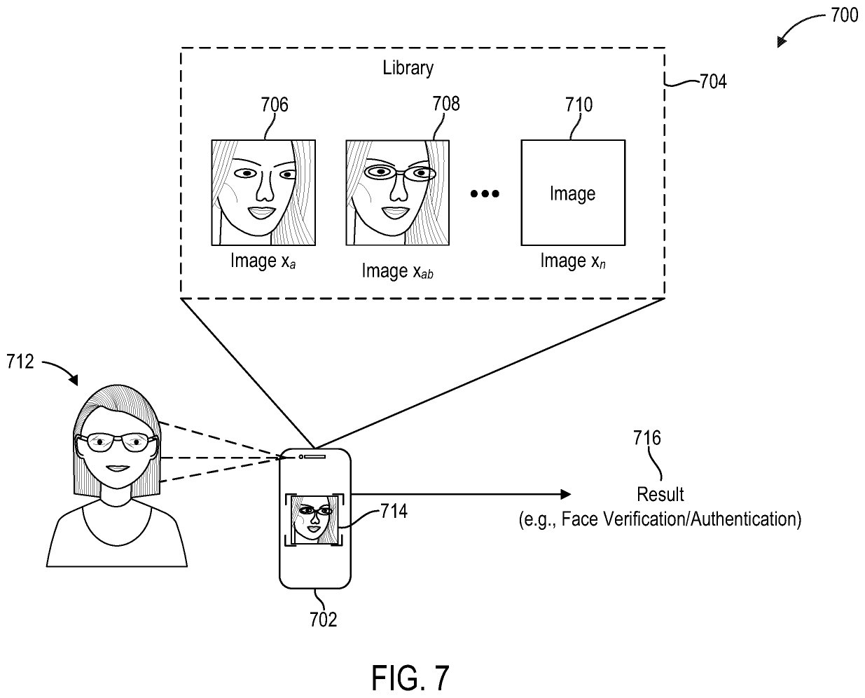

FIG. 7 illustrates an example facial verification use case 700. In this example, the facial verification can be performed based on a library 704 of facial verification images. The library 704 can include facial verification images 706-710 from different attribute domains, such as an attribute domain representing faces without eye glasses (e.g., domain a), an attribute domain representing faces with eye glasses (e.g., domain b), an attribute domain representing facial images with a certain background or brightness (e.g., domain n), etc.

Moreover, at least some of the facial verification images 706-710 in the library 704 can be generated based on the system flow 200 shown in FIG. 2. For example, facial verification image 706 can be an image generated for the user 712 during enrollment, and facial verification image 708 can be an image generated by the image processing system 100 based on the system flow 200 to include (or transfer) certain visual attributes (e.g., eye glasses) that are not included in the facial verification image 706. This way, the image processing system 100 can maintain a more robust or complete library of facial verification images, including images with visual attribute variations which can increase facial verification accuracy and avoid or limit issues that may otherwise arise due to visual attribute changes such as occlusions (e.g., scarves, eye glasses, hats, etc.), illumination changes, facial attribute changes (e.g., makeup, expressions, facial hair, scars, aging, etc.), and so forth.

In the example use case 700, the user 712 can first trigger facial verification or authentication at the device 702. The user 712 can trigger facial verification or authentication by, for example, attempting to access data or features that require user verification or authentication, requesting to be verified or authenticated by the device 702, etc. The device 702 can be any computing device such as, for example and without limitation, a mobile phone, a tablet computer, a gaming system, a laptop computer, a desktop computer, a server, an IoT device, an authentication or verification system, or any other computing device. Moreover, in some examples, the device 702 can implement the image processing system 100 shown in FIG. 1. In other examples, the device 702 can be separate from the image processing system 100. For example, the device 702 can be a separate device that obtains facial verification images and/or libraries of facial verification images from the image processing system 100.

When the user 712 triggers facial verification or authentication, the device 702 can capture a facial image 714 of the user 712, which the device 702 can use for the facial verification or authentication. The device 702 can capture the facial image 714 using one or more image sensors, such as image sensors 102 and/or 104. The one or more image sensors can scan and/or align the face of the user 712 to ensure the facial image 714 obtained is of sufficient quality (e.g., captures sufficient facial features for verification or authentication, is sufficiently lit to detect facial features, does not have so many obstructions or noise as to prevent adequate facial feature detection, captures an adequate view or angle of the face of the user 712, etc.) to perform facial verification or authentication.

The device 702 can then compare the facial image 714 captured for the user 712 with the facial verification images 706-710 in the library 704 to determine if the user 712 can be verified or authenticated. If the facial image 714 matches or has a threshold similarity to a facial verification image in the library 704, the device 702 can verify or authenticate the user 712. Otherwise, the device 702 can determine that the facial verification or authentication of the user 712 failed.

The device 702 can then generate a result 716, which can indicate whether the user 712 is verified or authenticated. For example, the device 702 can generate a result 716 indicating that the facial verification or authentication failed or succeeded. If the user 712 is successfully verified or authenticated, the device 702 can grant the user 712 access to the device 702 and/or data on the device 702. If the facial verification or authentication fails, the device 702 can prevent certain access by the user 712 to the device 702 and/or data on the device 702. In some cases, the device 702 can allow a certain number of retries before locking the device 702, erasing the data on the device 702, preventing additional facial verification or authentication attempts for a period of time, etc.

While the use case 700 in this example was described with respect to an example facial verification or authentication procedure, similar steps or strategies can be implemented for other procedures such as enrollment, training, testing, etc. For example, in some cases, the device 702 can capture the facial image 714 as part of an enrollment by the user 712. The device 702 can then store the facial image 714 in the library 704 and use the approaches herein to supplement the library 704 with other facial verification images containing (or removing) visual attributes from one or more attribute domains. To illustrate, if the facial image 714 captures the face of the user 712 with eye glasses, the device 702 can generate a facial image without the glasses (e.g., by removing the eye glasses as described herein) or a facial image with one or more different visual attributes such as a hat, a different background, different illumination, etc. The device 702 can then supplement the library 704 with the additional facial images generated, which capture visual attribute variations and can improve facial verification or authentication accuracy as previously explained.

Having disclosed example systems and concepts, the disclosure now turns to the example method 800 for transferring visual attributes to images, shown in FIG. 8. For the sake of clarity, the method 800 is described with reference to the image processing system 100, as shown in FIG. 1, configured to perform the various steps in the method 800. However, one of ordinary skill will appreciate that the method 800 can be performed using any suitable device or system. The steps outlined herein are examples and can be implemented in any combination thereof, including combinations that exclude, add, or modify certain steps.

At step 802, the image processing system 100 can obtain a first image (e.g., input image 202) associated with a user (e.g., 712). In some examples, the image processing system 100 can save the first image obtained in a library of user verification images. The first image can be a facial verification image that captures a face and/or facial features of the user. The first image can be captured by a camera or image sensor, such as image sensor(s) 102 and/or 104. In some non-limiting examples, the first image can be captured during an enrollment by the user, a facial verification or authentication procedure initiated by the user, and/or otherwise generated for use in facial verification or authentication of the user.

In some cases, the first image can be a facial verification image of the user captured by image sensor(s) 102 and/or 104, and provided to the image processing system 100 by the image sensor(s) 102 and/or 104. In other cases, the first image can be a facial verification image of the user received by the image processing system 100 from a separate or remote device, such as a separate or remote camera, server, client device, etc.

At step 804, the image processing system 100 can generate (e.g., via the generator 122A or 122B) a second image (e.g., target image 206B, target image 206A) including image data from the first image modified to add a first visual attribute transferred from one or more images or remove a second visual attribute in the image data. For example, the image processing system 100 can generate a synthetic image that captures a user's face, and adds one or more visual attributes (e.g., eye glasses, hat, color, background, brightness, etc.) transferred from one or more images and/or removes one or more visual attributes from the second image.

In some cases, the one or more images from which the first visual attribute can be transferred can include a set of sample facial images. Moreover, in some cases, the one or more images from which the first visual attribute can be transferred can include the first image obtained at step 802. For example, in some implementations, the one or more images can include the first image, and the second image can be generated by transferring the first visual attribute from the first image to the second image.

In some cases, the image processing system 100 can transfer the first visual attribute from the first image to the second image while maintaining facial identity information associated with the first image and/or the second image. For example, the image processing system 100 can transfer a visual attribute from the first image to the second image without changing the face identity information of the first image and/or the second image.

In some aspects, the image data in the second image can include a set of image data from the first image, and the set of image data from the first image can include the second visual attribute. In some implementations, generating the second image can include removing the second visual attribute from the image data associated with the second image and/or the set of image data from the first image. Moreover, the second visual attribute can be removed from the image data associated with the second image and/or the set of image data from the first image while maintaining facial identity information associated with the first image and/or the second image.

In some cases, the image processing system 100 can generate the second image based on sample or training facial images having different visual attributes. The sample or training facial images can be used to train the image processing system 100 to process, detect, extract, transfer, and/or remove the different visual attributes. In some cases, the different visual attributes, the first visual attribute, and/or the second visual attribute can include eye glasses, clothing apparel (e.g., a hat, a scarf, etc.), hair, one or more color features, one or more brightness features, one or more image background features, and/or one or more facial features (e.g., facial hair, face scar, makeup, facial edema, etc.).

At step 806, the image processing system 100 can compare a first set of features from the first image with a second set of features from the second image. The image processing system 100 can compare the first and second set of features in the first and second images to determine if the first and second images match at least partially. In some examples, the image processing system 100 can compare the first and second set of features to determine a comparison result or score representing an estimated degree of match (and/or differences) between the first and second images (and the first and second set of features). The comparison result or score can be, for example and without limitation, a discriminator result or score (e.g., a result or score calculated by discriminator 124A or 124B), a result or score calculated based on a loss function (e.g., a result or score representing a probability of the first and second images matching based on an amount of loss or a result or score representing an amount of loss or error associated with the comparison of the first and second images), an inception score, etc.

In some cases, the image processing system 100 can determine whether the first image and the second image match at least partially using one or more Variational Autoencoder-Generative Adversarial Networks (VAE-GANs). Each of the one or more VAE-GANs can include, for example, an encoder (e.g., 120A, 120B), a generator (e.g., 122A, 122B), a discriminator (e.g., 124A, 124B), and/or an identifier (e.g., 126). In some implementations, the image processing system 100 can use the discriminator (e.g., 124A, 124B) to compare the first set of features from the first image with the second set of features from the second image in order to determine whether the first image and the second image match at least partially and/or distinguish between the first image and the second image.

Moreover, in some examples, the image processing system 100 can use the discriminator (e.g., 124A, 124B) to distinguish between the second image and one or more sample images such as the first image and/or a set of training images. In some examples, the image processing system 100 can use the discriminator to distinguish between the second image and the first image and/or one or more sample images in order to optimize the quality or apparent authenticity of the second image so that it appears to be a real or authentic image or a real or authentic version of the first image (e.g., as opposed to a fake or synthetic image). For example, the image processing system 100 can use a generator (e.g., 122A, 122B) to generate the second image and make the second image appear authenticate, and implement the discriminator to analyze the second image to try to detect whether the second image is real/authentic or fake/synthetic. If the discriminator detects that the second image is fake/synthetic, the image processing system 100 can have the generator produce another version of the second image with the goal of producing an image that appears more authentic or realistic and/or is not recognized by the distinguisher as a fake/synthetic image.

In some implementations, the image processing system 100 can use a discriminator (e.g., 124A, 124B) to determine whether the second image has the first or second visual attribute and/or distinguish the second image from other images that have the first or second visual attribute. For example, the image processing system 100 can use the discriminator to verify that a visual attribute, such as eye glasses, added to the second image is detected or recognized by the discriminator.

At step 808, the image processing system 100 can determine, based on a comparison result, whether the first image and the second image match at least partially. The image processing system 100 can determine whether the first image and the second image match at least partially based on the comparison result at step 806. The comparison can generate a comparison result, such as a score, which can be used to determine whether the first and second images match at least partially. As previously noted, the comparison result can be, for example and without limitation, a discriminator result or score (e.g., a score calculated by discriminator 124A or 124B), a result or score calculated based on a loss function (e.g., a score representing a probability of the first and second images matching based on an amount of loss or a score representing an amount of loss or error associated with the comparison of the first and second images), an inception score, etc.

In some examples, determining whether the first image and the second image match at least partially can involve determining (e.g., via identifier 126) whether a face captured by the first image corresponds to a same user as a face captured by the second image. In other words, the image processing system 100 can verify that the first image and the second image both capture the face of a same user.

In some cases, when determining whether the first image and the second image match at least partially, the image processing system 100 can compare (e.g., at step 806) a first image data vector (e.g., the first set of features) associated with the first image with a second image data vector (e.g., the second set of features) associated with the second image, and determine whether the first image data vector associated with the first image and the second image data vector associated with the second image match at least partially. The second image data vector can include the image data associated with the second image. Moreover, in some cases, the image data associated with the second image can include at least a portion of the image data from the first image.

At step 810, when the first image and the second image match at least partially, the image processing system 100 can update a library (e.g., 704) of user verification images (e.g., 202, 206A, 206B, 706, 708, 710) to include the second image. The image processing system 100 can use the user verification images in the library to perform user or facial verifications or authentications as described herein. The user verification images can include different visual attributes such as facial attribute variations, background variations, brightness or color variations, and/or any other visual attribute variations. Moreover, the image processing system 100 can generate the second image and store it in the library of user verification images to augment the number of user verification images and/or visual attribute variations available in the library for use in facial verifications or authentications.

In some cases, in response to a request by the user (e.g., 712) to authenticate at a device (e.g., 702) containing the library (e.g., 704) of user verification images, the image processing system 100 can capture a third image of the user's face, compare the third image with one or more images in the library of user verification images, and authenticate the user at the device when the third image matches at least one of the one or more images. In some examples, the user verification images in the library can include the first image and/or the second image.

In some cases, when comparing the third image with the one or more images in the library of user verification images, the image processing system 100 can compare one or more features extracted from the third image with one or more features extracted from the one or more images, and determine whether the one or more features extracted from the third image and at least some of the one or more features extracted from the one or more images match. In some examples, the at least some of the one or more features extracted from the one or more images can correspond to a particular image from the one or more images.

Moreover, in some cases, when comparing the third image with the one or more images in the library of user verification images, the image processing system 100 can compare identity information (e.g., a facial identity) associated with the third image (e.g., corresponding to a face captured by the third image) with identity information associated with the one or more images, and determine whether the identity information associated with the third image and the identity information associated with the one or more images correspond to a same user. This way, the image processing system 100 can verify that the third image and the one or more images depict the face of the same user.

In some cases, the image processing system 100 can enroll one or more facial images associated with the user into the library of user verification images. Moreover, the image processing system 100 can generate the second image based on a facial image from the one or more facial images and/or one or more training or sample facial images having one or more different visual attributes than the facial image from the one or more facial images. In some implementations, when enrolling the one or more facial images, the image processing system 100 can extract a set of features from each facial image in the one or more facial images and store the set of features in the library of user verification images. Further, in some cases, generating the second image can include transferring at least some of the one or more different visual attributes from the one or more training or sample facial images to the image data associated with the second image. In some cases, the image data associated with the second image can be generated based on the first image.

In some examples, the method 800 can be performed by a computing device or an apparatus such as the computing device 900 shown in FIG. 9, which can include or implement the image processing system 100 shown in FIG. 1. In some cases, the computing device or apparatus may include a processor, microprocessor, microcomputer, or other component of a device that is configured to carry out the steps of method 800. In some examples, the computing device or apparatus may include an image sensor (e.g., 102 or 104) configured to capture images and/or image data. For example, the computing device may include a mobile device with an image sensor (e.g., a digital camera, an IP camera, a mobile phone or tablet including an image capture device, or other type of device with an image capture device). In some examples, an image sensor or other image data capturing device can be separate from the computing device, in which case the computing device can receive the captured images or image data.

In some cases, the computing device may include a display for displaying the output images. The computing device may further include a network interface configured to communicate data, such as image data. The network interface may be configured to communicate Internet Protocol (IP) based data or other suitable network data.

Method 800 is illustrated as a logical flow diagram, the steps of which represent a sequence of steps or operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like, that perform particular functions or implement particular data types. The order in which the operations are described is not intended to be construed as a limitation or requirement, and any number of the described operations can be combined in any order and/or in parallel to implement the processes.

Additionally, the method 800 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 illustrates an example computing device architecture of an example computing device 900 which can implement the various techniques described herein. For example, the computing device 900 can implement the image processing system 100 shown in FIG. 1 and perform the image processing techniques described herein.

The components of the computing device 900 are shown in electrical communication with each other using a connection 905, such as a bus. The example computing device 900 includes a processing unit (CPU or processor) 910 and a computing device connection 905 that couples various computing device components including the computing device memory 915, such as read only memory (ROM) 920 and random access memory (RAM) 925, to the processor 910. The computing device 900 can include a cache of high-speed memory connected directly with, in close proximity to, or integrated as part of the processor 910. The computing device 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions.

Other computing device memory 915 may be available for use as well. The memory 915 can include multiple different types of memory with different performance characteristics. The processor 910 can include any general purpose processor and a hardware or software service, such as service 1 932, service 2 934, and service 3 936 stored in storage device 930, configured to control the processor 910 as well as a special-purpose processor where software instructions are incorporated into the processor design. The processor 910 may be a self-contained system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art, such as a display, projector, television, speaker device, etc. In some instances, multimodal computing devices can enable a user to provide multiple types of input to communicate with the computing device 900. The communications interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include services 932, 934, 936 for controlling the processor 910. Other hardware or software modules are contemplated. The storage device 930 can be connected to the computing device connection 905. In one aspect, a hardware module that performs a particular function can include the software component stored in a computer-readable medium in connection with the necessary hardware components, such as the processor 910, connection 905, output device 935, and so forth, to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method comprising:
obtaining a first image associated with a user;
generating a second image comprising image data from the first image modified to add a first visual attribute transferred from one or more images or to remove a second visual attribute in the image data;
comparing a first set of features from the first image with a second set of features from the second image;
determining, based on a comparison result, whether the first image and the second image match at least partially; and
when the first image and the second image match at least partially, updating a library of user verification images to include the second image.

2. The method of claim 1, further comprising:
in response to a request by the user to authenticate at a device containing the updated library of user verification images, capturing a third image of the user;
comparing the third image with one or more user verification images in the library of user verification images, the user verification images comprising at least one of the first image and the second image; and
when the third image matches at least one of the one or more user verification images, authenticating the user at the device.

3. The method of claim 2, wherein comparing the third image with the one or more user verification images in the library of user verification images comprises:
comparing identity information associated with the third image with identity information associated with the one or more user verification images; and
determining whether the identity information associated with the third image and the identity information associated with the one or more user verification images correspond to a same user.

4. The method of claim 2, wherein comparing the third image with the one or more user verification images in the library of user verification images comprises:
comparing one or more features extracted from the third image with a set of features extracted from the one or more user verification images; and
determining whether the one or more features extracted from the third image and at least some of the set of features extracted from the one or more user verification images match.

5. The method of claim 1, wherein determining whether the first image and the second image match at least partially comprises:
comparing a first image data vector associated with the first image with a second image data vector associated with the second image, the second image data vector comprising the image data associated with the second image; and
determining whether the first image data vector associated with the first image and the second image data vector associated with the second image match at least partially.

6. The method of claim 1, wherein generating the second image comprises transferring the first visual attribute from the first image to the second image, wherein the transferring of the first visual attribute is performed while maintaining facial identity information associated with at least one of the first image and the second image.

7. The method of claim 1, wherein image data from the first image comprises the second visual attribute, and wherein generating the second image comprises removing the second visual attribute from the image data, the second visual attribute being removed from the image data while maintaining facial identity information associated with at least one of the first image and the second image.

8. The method of claim 1, wherein generating the second image and determining whether the first image and the second image match at least partially are performed using one or more Variational Autoencoder-Generative Adversarial Networks (VAE-GANs), wherein each of the one or more VAE-GANs comprises at least one of an encoder, a generator, a discriminator, and an identifier.

9. The method of claim 1, wherein generating the second image is based on a plurality of training facial images having different visual attributes.

10. The method of claim 1, further comprising:
enrolling one or more facial images associated with the user into the library of user verification images; and
generating the second image based on at least one facial image from the one or more facial images and one or more training facial images having one or more different visual attributes than the at least one facial image from the one or more facial images.

11. The method of claim 10, wherein enrolling the one or more facial images comprises extracting a set of features from each facial image in the one or more facial images and storing the set of features in the library of user verification images, and wherein generating the second image comprises transferring at least some of the one or more different visual attributes from the one or more training facial images to the image data associated with the second image.

12. The method of claim 1, wherein the image data comprises a set of image data from a facial image generated based on the first image.

13. The method of claim 1, wherein the first visual attribute and the second visual attribute comprise at least one of eye glasses, clothing apparel, hair, one or more color features, one or more brightness features, one or more image background features, and one or more facial features.

14. An apparatus comprising:
a memory; and
a processor implemented in circuitry and configured to:
obtain a first image associated with a user;
generate a second image comprising image data from the first image modified to add a first visual attribute transferred from one or more images or to remove a second visual attribute in the image data;
compare a first set of features from the first image with a second set of features from the second image;
determine, based on a comparison result, whether the first image and the second image match at least partially; and
when the first image and the second image match at least partially, update a library of user verification images to include the second image.

15. The apparatus of claim 14, the processor being configured to:
in response to a request by the user to authenticate at a device containing the updated library of user verification images, capture a third image of the user;
compare the third image with one or more user verification images in the library of user verification images, the user verification images comprising at least one of the first image and the second image; and
when the third image matches at least one of the one or more user verification images, authenticate the user at the device.

16. The apparatus of claim 15, wherein comparing the third image with the one or more user verification images in the library of user verification images comprises:
comparing identity information associated with the third image with identity information associated with the one or more user verification images; and
determining whether the identity information associated with the third image and the identity information associated with the one or more user verification images correspond to a same user.

17. The apparatus of claim 15, wherein comparing the third image with the one or more user verification images in the library of user verification images comprises:
comparing one or more features extracted from the third image with a set of features extracted from the one or more user verification images; and
determining whether the one or more features extracted from the third image and at least some of the set of features extracted from the one or more user verification images match.

18. The apparatus of claim 14, wherein determining whether the first image and the second image match at least partially comprises:
comparing a first image data vector associated with the first image with a second image data vector associated with the second image, the second image data vector comprising the image data associated with the second image; and
determining whether the first image data vector associated with the first image and the second image data vector associated with the second image match at least partially.

19. The apparatus of claim 14, wherein generating the second image comprises transferring the first visual attribute from the first image to the second image, wherein the transferring of the first visual attribute is performed while maintaining facial identity information associated with at least one of the first image and the second image.

20. The apparatus of claim 14, wherein image data from the first image comprises the second visual attribute, and wherein generating the second image comprises removing the second visual attribute from the image data, the second visual attribute being removed from the image data while maintaining facial identity information associated with at least one of the first image and the second image.

21. The apparatus of claim 14, wherein generating the second image and determining whether the first image and the second image match at least partially are performed using one or more Variational Autoencoder-Generative Adversarial Networks (VAE-GANs), wherein each of the one or more VAE-GANs comprises at least one of an encoder, a generator, a discriminator, and an identifier.

22. The apparatus of claim 14, wherein generating the second image is based on a plurality of training facial images having different visual attributes.

23. The apparatus of claim 14, the processor being configured to:
enroll one or more facial images associated with the user into the library of user verification images; and
generate the second image based on at least one facial image from the one or more facial images and one or more training facial images having one or more different visual attributes than the at least one facial image from the one or more facial images.

24. The apparatus of claim 23, wherein enrolling the one or more facial images comprises extracting a set of features from each facial image in the one or more facial images and storing the set of features in the library of user verification images, and wherein generating the second image comprises transferring at least some of the one or more different visual attributes from the one or more training facial images to the image data associated with the second image.

25. The apparatus of claim 14, wherein the image data comprises a set of image data from a facial image generated based on the first image.

26. The apparatus of claim 14, wherein the first visual attribute and the second visual attribute comprise at least one of eye glasses, clothing apparel, hair, one or more color features, one or more brightness features, one or more image background features, and one or more facial features.

27. The apparatus of claim 14, further comprising a mobile computing device.

28. The apparatus of claim 14, further comprising at least one of an image sensor and a display device.

29. A non-transitory computer-readable storage medium having stored thereon instructions that, when executed by one or more processors, cause the one or more processors to:
obtain a first image associated with a user;
generate a second image comprising image data from the first image modified to add a first visual attribute transferred from one or more images or to remove a second visual attribute in the image data;
compare a first set of features from the first image with a second set of features from the second image;
determine, based on a comparison result, whether the first image and the second image match at least partially; and
when the first image and the second image match at least partially, update a library of user verification images to include the second image.

30. The non-transitory computer-readable storage medium of claim 29, wherein the instructions, when executed by the one or more processors, cause the one or more processors to:
in response to a request by the user to authenticate at a device containing the updated library of user verification images, capture a third image of the user;
compare the third image with one or more user verification images in the library of user verification images, the user verification images comprising at least one of the first image and the second image; and
when the third image matches at least one of the one or more user verification images, authenticate the user at the device.
